(19) United States
(12) Patent Application Publication
(10) Pub. No.: US 2025/0291342 A1
(43) Pub. Date: Sep. 18, 2025

(54) DATA MONITORING ASSISTANCE APPARATUS, METHOD, AND NON-TRANSITORY COMPUTER READABLE MEDIUM

(71) Applicant: KABUSHIKI KAISHA TOSHIBA, Tokyo (JP)

(72) Inventors: Wataru Watanabe, Tokyo (JP); Shintaro Yamamoto, Tokyo (JP); Toshiyuki Ono, Kawasaki Kanagawa (JP)

(73) Assignee: KABUSHIKI KAISHA TOSHIBA, Tokyo (JP)

(21) Appl. No.: 19/065,449

(22) Filed: Feb. 27, 2025

(30) Foreign Application Priority Data
Mar. 15, 2024 (JP) 2024-040743

(51) Int. Cl. G05B 23/02

(52) U.S. Cl. CPC G05B 23/0221; G05B 23/0272

(57) ABSTRACT

According to one embodiment, a data monitoring assistance apparatus includes a processor. The processor acquires a plurality of pieces of time-series data related to an operating state of a device during a predetermined period. The processor calculates an index value related to a possibility of occurrence of an anomaly sign in the device based on the pieces of time-series data. The processor calculates a contribution degree to the index value for each of the pieces of time-series data. The processor displays, on a display device, a display screen including first transition related to the index value during the predetermined period and second transition related to the contribution degree during the predetermined period.

### CROSS-REFERENCE TO RELATED APPLICATIONS

This application is based upon and claims the benefit of priority from Japanese Patent Application No. 2024-040743, filed Mar. 15, 2024, the entire contents of which are incorporated herein by reference.

### FIELD

Embodiments described herein relate generally to a data monitoring assistance apparatus, a method, and a non-transitory computer readable medium.

### BACKGROUND

With the recent development of Internet of Things (IoT) technology, predictive maintenance, which is an evolution of condition based maintenance (CBM), has attracted attention as a device maintenance method. In predictive maintenance, a monitoring apparatus detects (or predicts) and presents an anomaly sign and an anomaly cause that can lead to a failure of a device based on operation data of the device obtained by the IoT technology. A user can determine appropriate maintenance time and maintenance work for the device before the device fails based on the detection result presented by the monitoring apparatus.

The operation data of the device includes a plurality of pieces of time-series data related to an operation state of the device. For example, the monitoring apparatus calculates an index value related to a possibility of occurrence of an anomaly sign in the device based on the plurality of pieces of time-series data. The monitoring apparatus calculates a contribution degree (or a contribution rate) to the index value for each of the plurality of pieces of time-series data. The monitoring apparatus presents the plurality of pieces of time-series data in a predetermined manner according to the value of the contribution degree.

However, if the monitoring apparatus only presents the plurality of pieces of time-series data, the user cannot recognize transition (or trend) of the degree of contribution.

### BRIEF DESCRIPTION OF DRAWINGS

FIG. 1 is a functional configuration diagram of a data monitoring assistance apparatus according to a first embodiment.

FIG. 2 is an operation flowchart of the data monitoring assistance apparatus according to the first embodiment.

FIG. 3 is a diagram illustrating operation data according to the first embodiment.

FIG. 4 is a diagram illustrating a display screen according to the first embodiment.

FIG. 5 is a functional configuration diagram of a data monitoring assistance apparatus according to Modification 1 of the first embodiment.

FIG. 6 is a functional configuration diagram of a data monitoring assistance apparatus according to Modification 2 of the first embodiment.

FIG. 7 is a functional configuration diagram of a data monitoring assistance apparatus according to a second embodiment.

FIG. 8 is an operation flowchart of the data monitoring assistance apparatus according to the second embodiment.

FIG. 9 is a diagram illustrating a display screen according to the second embodiment.

FIG. 10 is a functional configuration diagram of a data monitoring assistance apparatus according to Modification 3 of the second embodiment.

FIG. 11 is a diagram illustrating a line graph according to Modification 3 of the second embodiment.

FIG. 12 is a functional configuration diagram of a data monitoring assistance apparatus according to a third embodiment.

FIG. 13 is an operation flowchart of the data monitoring assistance apparatus according to the third embodiment.

FIG. 14 is a functional configuration diagram of a data monitoring assistance apparatus according to a fourth embodiment.

FIG. 15 is an operation flowchart of the data monitoring assistance apparatus according to the fourth embodiment.

FIG. 16 is a diagram illustrating a display screen according to the fourth embodiment.

FIG. 17 is a functional configuration diagram of a data monitoring assistance apparatus according to Modification 4 of the fourth embodiment.

FIG. 18 is a diagram illustrating a first example of a display screen according to a fifth embodiment.

FIG. 19 is a diagram illustrating a second example of a display screen according to the fifth embodiment.

FIG. 20 is a hardware configuration diagram of the data monitoring assistance apparatus according to each embodiment.

### DETAILED DESCRIPTION

In general, according to one embodiment, a data monitoring assistance apparatus includes a processor. The processor acquires a plurality of pieces of time-series data related to an operating state of a device during a predetermined period. The processor calculates an index value related to a possibility of occurrence of an anomaly sign in the device based on the pieces of time-series data. The processor calculates a contribution degree to the index value for each of the pieces of time-series data. The processor displays, on a display device, a display screen including first transition related to the index value during the predetermined period and second transition related to the contribution degree during the predetermined period.

Hereinafter, embodiments will be described with reference to the drawings. In each embodiment, it is assumed that a plurality of portions given an identical reference sign perform similar operations, and repeated description thereof will be omitted as appropriate.

### First Embodiment

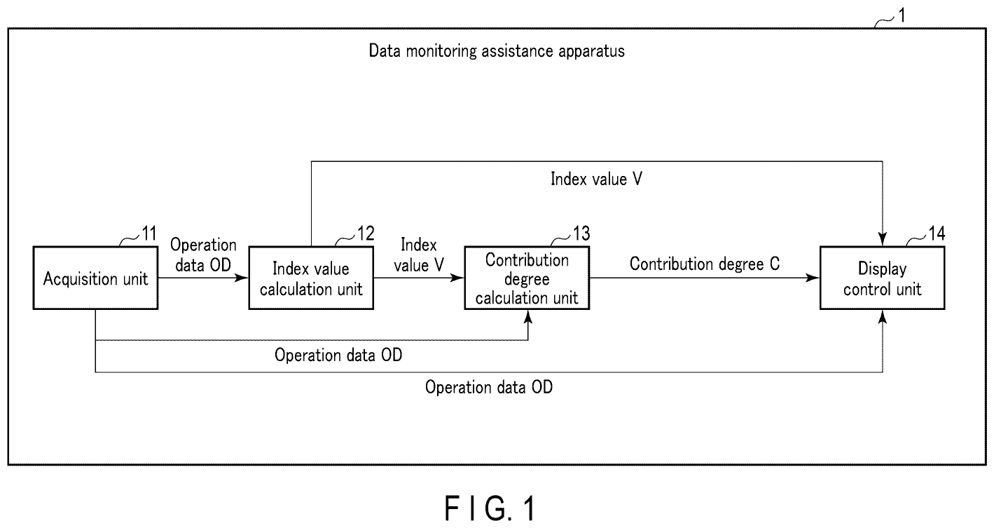

FIG. 1 is a functional configuration diagram of a data monitoring assistance apparatus 1 according to a first embodiment. The data monitoring assistance apparatus 1 is an apparatus that assists monitoring of data (operation data OD) related to an operation state of a device. The data monitoring assistance apparatus 1 includes an acquisition unit 11, an index value calculation unit 12, a contribution degree calculation unit 13, and a display control unit 14.

Examples of the device to be monitored include a station service device (a ticket checking and collecting machine, a ticket vending machine), a bill processor, a multifunction printer, and an elevating machine (an elevator, an escalator). These devices need maintenance for preventing a failure in advance since an operating period thereof is long and occurrence of a failure gives large influence. Furthermore, these devices have a complicated mechanism, and there are many types of failure places and failure contents, and therefore assistance for determination of maintenance time and maintenance work is useful. The device to be monitored may be a manufacturing device in a manufacturing industry or a process-related device (for example, a chemical plant).

The operation data OD may include a plurality of pieces of time-series data TD acquired from various sensors installed in the device to be monitored. The operation data OD may include values sampled from various sensors at any time intervals (for example, one day).

The acquisition unit 11 acquires various data. The acquisition unit 11 acquires the operation data OD related to the operation state of the device during a predetermined period. The operation data OD includes the plurality of pieces of time-series data TD. The acquisition unit 11 transmits the acquired operation data OD to the index value calculation unit 12, the contribution degree calculation unit 13, and the display control unit 14.

The index value calculation unit 12 calculates various index values. The index value calculation unit 12 calculates an index value V concerning a possibility of occurrence of an anomaly sign in the device based on the plurality of pieces of time-series data TD included in the operation data OD. The index value calculation unit 12 transmits the calculated index value V to the contribution degree calculation unit 13 and the display control unit 14.

The contribution degree calculation unit 13 calculates various contribution degrees. The contribution degree calculation unit 13 calculates a contribution degree C. to the index value V for each of the plurality of pieces of time-series data TD included in the operation data OD. The contribution degree calculation unit 13 transmits the calculated contribution degree C. to the display control unit 14.

The display control unit 14 controls various kinds of display. The display control unit 14 displays, on a display device, a display screen including transition (first transition) related to the index value V during a predetermined period of the operation data OD and transition (second transition) related to the contribution degree C. during the predetermined period of the operation data OD. The display control unit 14 may display transition (third transition) related to the plurality of pieces of time-series data TD during the predetermined period of the operation data OD.

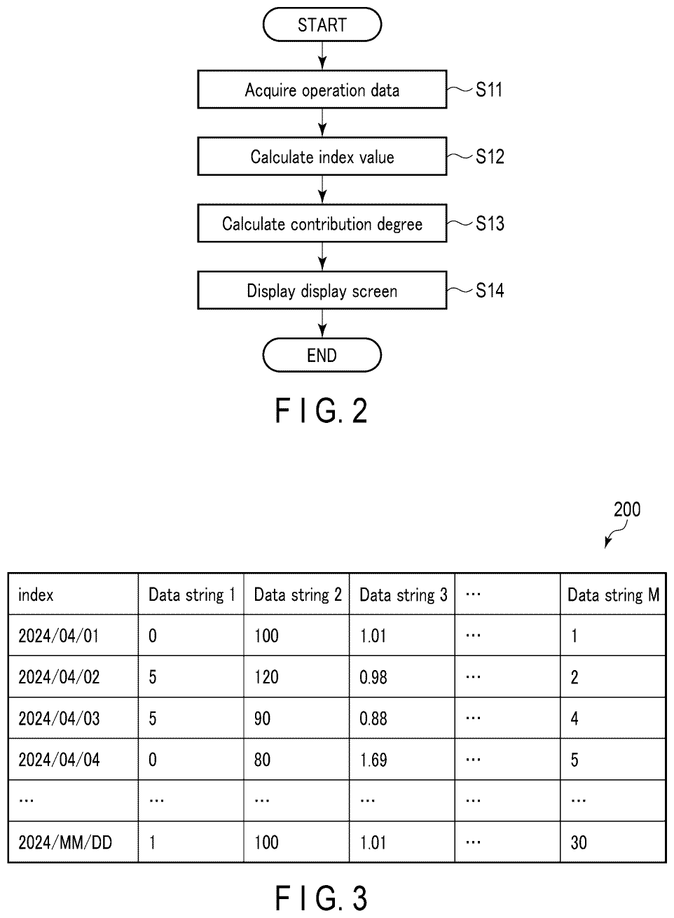

FIG. 2 is an operation flowchart of the data monitoring assistance apparatus 1 according to the first embodiment. The data monitoring assistance apparatus 1 executes processes related to steps S11 to S14.

(Step S11) First, the data monitoring assistance apparatus 1 acquires the operation data OD through the acquisition unit 11. The acquisition unit 11 acquires the operation data OD from an outside of the data monitoring assistance apparatus 1. The operation data OD includes the plurality of pieces of time-series data TD (see FIG. 3), as described above.

The acquisition unit 11 may directly acquire the operation data OD from the device. The acquisition unit 11 may acquire the operation data OD from an external database. The acquisition unit 11 may acquire the operation data OD from an external data file recorded in any format (for example: TXT, CSV, JSON).

The acquisition unit 11 may process (pre-process) the acquired operation data OD. The acquisition unit 11 may acquire the operation data OD processed by another functional unit (for example, a data processing unit). A known method can be applied to process the operation data OD.

For example, the acquisition unit 11 processes a missing value of the operation data OD. In many cases, the missing value is expressed according to a specific rule (for example: blank, N/A, 0). Mixture of numerical values and character strings in the operation data OD is not suitable for monitoring or analyzing the operation data OD. Therefore, the acquisition unit 11 may replace the missing value with a specific numerical value or character string. The acquisition unit 11 may interpolate the missing value in a time direction or may interpolate the missing value by using a plurality of types of data. A known method can be applied to the replacement or interpolation of the missing value.

(Step S12) Next, the data monitoring assistance apparatus 1 calculates the index value V through the index value calculation unit 12. The index value calculation unit 12 calculates the index value V based on the operation data OD acquired in step S11. A known method can be applied to the calculation of the index value V.

The index value V may be a numerical value (deviation degree) based on a distance between data (normal data) during a period where the device is normal and the operation data OD related to the device. The index value V may be a numerical value (failure degree) indicating severity of a failure of the device or may be a numerical value (failure probability) indicating probability of occurrence of a failure in the device. The index value V may be a numerical value (a degree of importance) indicating importance related to maintenance of the device or may be a numerical value (a degree of urgency) indicating urgency related to maintenance of the device.

For example, the index value calculation unit 12 calculates the deviation degree as the index value V. As described above, the index value calculation unit 12 calculates the distance between the data (normal data) during the period where the device is normal and the operation data OD related to the device by using the normal data and the operation data OD.

The normal data may be data during a period where it is known that there is no failure or trouble in the device. The normal data may be data immediately after the device is newly introduced or may be data at a time of an operation test before shipment of the device. The normal data may be simulation data obtained by simulatively reproducing a state in which the device is normal.

In a case where there is another device having the same format as that of the device to be monitored, the normal data of the device to be monitored may be data of the other device during a normal state. In a case where there are a plurality of devices having the same format as that of the device to be monitored, the normal data of the device to be monitored may be a set of data related to the plurality of devices.

A large part of the predetermined period related to the operation data OD of the device may be a period where the device is normal, and a small part of the predetermined period may be a period where the device has a failure or trouble. In this case, the index value calculation unit 12 may consider that the large part of the predetermined period related to the operation data OD of the device is normal. The index value calculation unit 12 may derive the normal data by excluding a statistical outlier from the operation data OD of the device.

The index value calculation unit 12 may further process the calculated index value V. The index value calculation unit 12 may normalize (or scale) the calculated index value V so that a minimum value of the processed index value V is 0 and a maximum value of the processed index value V is 1. In this case, the closer the index value V is to 1, the larger the deviation degree is. In a case where the distance is used as the deviation degree, a maximum value of the distance changes according to a value range or numerical value of the operation data OD. Due to the normalization, the deviation degree is easy to interpret. Furthermore, deviation degrees of a plurality of devices are easily compared among a plurality of types of data.

The index value calculation unit 12 may execute time-series smoothing on the calculated deviation degree. For example, the index value calculation unit 12 uses a moving average of the operation data OD during a predetermined period (for example, past one week) as the deviation degree.

(Step S13) Subsequently, the data monitoring assistance apparatus 1 calculates the contribution degree C. through the contribution degree calculation unit 13. The contribution degree calculation unit 13 uses the operation data OD acquired in step S11 and the index value V calculated in step S12. The contribution degree calculation unit 13 calculates a contribution degree C. to the index value V for each of the plurality of pieces of time-series data TD included in the operation data OD. A known method can be applied to the calculation of the contribution degree C.

The contribution degree calculation unit 13 may further process the calculated contribution degree C. The contribution degree calculation unit 13 may normalize (or scale) the calculated contribution degree C. so that a minimum value of the processed contribution degree C. is 0 and a maximum value of the processed contribution degree C. is 1. The contribution degree calculation unit 13 may normalize the contribution degrees C. of the plurality of pieces of time-series data TD so that the sum of the contributions C of the plurality of pieces of time-series data TD is 100%. Due to the normalization, how high the contribution degrees C. of the plurality of pieces of time-series data TD are is intuitively and easily interpreted as a percentage (%).

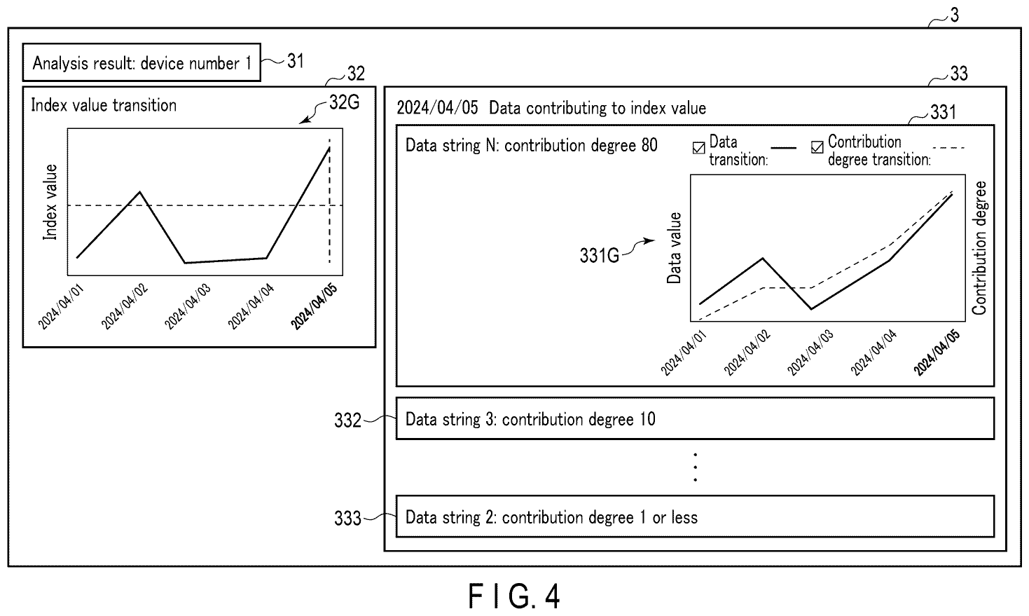

(Step S14) Finally, the data monitoring assistance apparatus 1 displays a display screen through the display control unit 14. The display control unit 14 uses the operation data OD acquired in step S11 and the index value V and the contribution degree C. calculated in steps S12 and S13. The display control unit 14 generates display data (or image data) for displaying the display screen based on the operation data OD, the index value V, and the contribution degree C. The display control unit 14 outputs the generated display data to the display device. The display device displays the display screen based on the output display data (see FIG. 4).

A format of the display data may be any format (for example: PNG, JPEG, PDF, HTML). The display device may display the display screen based on the display data in any format. For example, the display control unit 14 outputs the display data to the display device in a JSON format. The display device may display the display screen based on the output display data in an HTML format on a browser.

FIG. 3 is a diagram illustrating the operation data OD according to the first embodiment. The operation data OD is recorded by a table 200. In the table 200, data is recorded in a row direction (vertical direction), and a kind of data (data string) is recorded in a column direction (horizontal direction).

In the row direction of the table 200, data for each day is recorded. In the leftmost column of the table 200, a date corresponding to each data is recorded as “index”. In remaining columns of the table 200, M kinds of data strings (that is, the time-series data TD) are recorded.

The table 200 may record data for each time interval, which can be any time interval (for example: 1 hour, 1 week). A data period of a certain row and a data period of a row adjacent to this row may overlap each other. For example, a data period of a certain row is “9:00 to 11:00”, and a data period of the next row is “10:00 to 12:00”. In a case where data occurs irregularly, the index need not be equal time intervals. The index may be a number or a character string indicating an order in which data is acquired.

In the column direction of the table 200, data for each data string is recorded. Each data string may be data (operation data) related to operation of the device or may be data (state data) related to a state of the device. The operation data is a measurement value (for example: the number of times of operation, number of times of error occurrence) or the like obtained by measuring the operation of the device by a sensor or the like. The state data is a measurement value (for example: temperature, humidity, voltage, speed) or the like obtained by measuring the state of the device by a sensor or the like.

In a case where the device includes a plurality of modules (parts), each data string may be a measurement value or the like for each module. In a case where there are a plurality of types of operation or errors of the device, the operation data may be a measurement value or the like for each type.

(Preprocessing) The acquisition unit 11 may preprocess the table 200. For example, the acquisition unit 11 performs difference processing in the row direction (time direction) of the table 200. In a case where the sensor installed in the device is a counter, the data string M records a monotonically increasing numerical value from the counter. The acquisition unit 11 may calculate a difference (that is, increment) between rows in the data string M. By the difference processing, a change in the numerical value per day is easily monitored.

For example, the acquisition unit 11 performs smoothing or denoising in the row direction of the table 200. The acquisition unit 11 rearranges the data recorded in the table 200 in chronological order by the index. The acquisition unit 11 calculates a moving average between the rearranged data. By the calculation of the moving average, rapid data fluctuation (for example: spike noise) is suppressed.

For example, the acquisition unit 11 performs four arithmetic operations among the plurality of data strings in the table 200. The acquisition unit 11 may calculate a ratio by division. It is assumed that the data string 1 is the “number of times of error occurrence” and the data string 2 is the “total number of times of operation”. In this case, (the data string 1)/(the data string 2) means the number of times of error occurrence (error occurrence rate) in the total number of times of operation. (Calculation of index value) The index value calculation unit 12 may calculate the index value V corresponding to each row (that is, each day) of the table 200. The index value calculation unit 12 may calculate the index value V for a specific row in the table 200.

For example, the index value calculation unit 12 calculates the index value V for data of the latest index in the table 200. The index value calculation unit 12 may calculate the index value V for an index designated from the outside. The index value calculation unit 12 may calculate one index value V for data of one row (one-to-one correspondence). The index value calculation unit 12 may calculate one index value V for data of a plurality of rows (many-to-one correspondence). The index value calculation unit 12 may calculate one index value V for data of past one week including a designated date.

The index value calculation unit 12 may calculate the deviation degree, which is an example of the index value V, as a known distance (for example: Euclidean distance). In a case where a plurality of rows (certain period) in the table 200 are normal data, the index value calculation unit 12 may calculate a statistical value (for example: an average, a median) of the plurality of rows as new normal data. The index value calculation unit 12 may calculate the deviation degree for each of the plurality of rows and calculate a statistical value (for example: an average, a median) of the calculated deviation degrees as a new deviation degree.

In a case where a plurality of rows (certain period) in the table 200 are normal data, the index value calculation unit 12 may construct a model for calculating a deviation degree and calculate a deviation degree according to the constructed model. The index value calculation unit 12 may calculate an average and a variance of the normal data of the plurality of rows and calculate a deviation degree by a Mahalanobis distance.

The model for calculating the deviation degree may be constructed by a machine learning method. The machine learning method is roughly divided into “supervised learning” and “unsupervised learning”. In the supervised learning, a certain amount of data during occurrence of a failure of the device is needed as training data. In a case where training data is prepared, the model is constructed by a known method (for example: regression, decision tree, deep learning).

On the other hand, there is a case where a certain amount of data during occurrence of a failure of the device, which is needed as training data, is not prepared, for example, because a failure of the device rarely occurs. In this case, unsupervised learning is often applied. As a method of unsupervised learning, One-Class SVM or k-nearest neighbor algorithm may be applied. The deviation degree in the One-Class SVM may be a distance from a discriminant plane. The deviation degree in the k-nearest neighbor algorithm may be a statistical value (for example: a sum, an average, a maximum value) related to distances between target data and K pieces of neighbor data.

The index value calculation unit 12 may construct a model by a deep learning method. For example, the index value calculation unit 12 constructs a normal model based on an auto encoder. The index value calculation unit 12 trains a neural network of the auto encoder so that input data is restored. For example, the index value calculation unit 12 trains the auto encoder by using normal data as input data. The trained auto encoder can accurately reconstruct data similar to that in a period where the device is normal. On the other hand, a reconstruction error increases as for data different from the data in the period where the device is normal. In this case, the reconstruction error may be used as the deviation degree. The reconstruction error may be a known error measure (for example, a mean square error).

As for unsupervised learning based on deep learning, many methods including extension of the auto encoder have been proposed. Many methods have also been proposed as for “few-shot learning” using a small amount of training data. The index value calculation unit 12 may use a proposed known method.

As described above, the index value calculation unit 12 may calculate one index value V for data of a plurality of rows of the table 200 (many-to-one correspondence). In this case, the machine learning model may receive the data of the plurality of rows as input data. Since data is recorded in chronological order in the table 200, a known chronological machine learning model (for example: hidden Markov model, LSTM, Transformer) may be used.

(Calculation of contribution degree) The contribution degree calculation unit 13 calculates the contribution degree C. of each data string to the index value V. As described above, the index value calculation unit 12 calculates the index value V for data of a certain row in the table 200 by using M kinds of data strings. The contribution degree calculation unit 13 calculates a degree of influence of each of the M kinds of data strings on the calculated index value V as the contribution degree C.

In a case where the index value calculation unit 12 calculates the index value V by the regression model, the contribution degree calculation unit 13 calculates an absolute value of a regression coefficient as the contribution degree C. In a case where the index value calculation unit 12 calculates the index value V by the Mahalanobis distance, the contribution degree calculation unit 13 subtracts an average of each data string from a value of the data string in the table 200 and then divides an obtained value by variance of the data string. In this manner, the contribution degree calculation unit 13 calculates the contribution degree C. for each data string. This means that, from the viewpoint of the Mahalanobis distance, a data string whose deviation degree from the normal data is larger has a larger contribution degree C.

In a case where a model based on deep learning is used, a method called attention is used as a method for evaluating a degree of influence of input data on output data. The contribution degree calculation unit 13 may calculate the contribution degree C. based on a value of attention with respect to the input data.

The contribution degree calculation unit 13 may use a general-purpose method that does not depend on the type of the model used to calculate the index value V. As the method, Feature Importance, Partial Dependence, Permutation Importance, Individual Conditional Expectation, LIME (see Non-Patent Document 1: Marco Ribeiro, Sameer Singh, and Carlos Guestrin, “Why Should I Trust You?”: Explaining the Predictions of Any Classifier, Proceedings of the 2016 Conference of the North American Chapter of the Association for Computational Linguistics: Demonstrations, 2016, pp. 97-101), SHAP (see Non-Patent Document 2: Scott M. Lundberg and Su-In Lee, “A Unified Approach to Interpreting Model Predictions”, Proceedings of the 31st International Conference on Neural Information Processing Systems, 2017, pp. 4768-4777), and the like have been proposed. Other methods similar to these methods may be used. These methods estimate a degree of influence (that is, the contribution degree C.) of input data on output data in a machine learning method. The contribution degree calculation unit 13 may calculate the contribution degree C. for each data string with respect to the index value V of data of a certain row in the table 200 based on the machine learning model used to calculate the index value V.

FIG. 4 is a diagram illustrating a display screen 3 according to the first embodiment. The display screen 3 shows an analysis result of the operation data OD regarding a certain device (device number 1). The display screen 3 includes three regions 31, 32, and 33.

The region 31 specifies the device whose operation data OD has been analyzed. The region 31 includes a text “Analysis result: device number 1”. the regions 32 and 33 show analysis results of the operation data OD regarding the device number 1.

The region 32 displays transition of the index value V calculated for the device number 1 as a line graph 32G. The vertical axis of the line graph 32G indicates the index value V. The horizontal axis of the line graph 32G indicates a date. The date corresponds to the index of the table 200. In particular, the index “2024 Apr. 5” is selected as an index to be monitored. The index to be monitored is highlighted in bold. In the line graph 32G, an auxiliary line is displayed in the vertical axis direction at a position of the index to be monitored. In the line graph 32G, an auxiliary line is displayed in the horizontal axis direction at a position of a threshold value concerning the index value V.

The index to be monitored may be any index. The index to be monitored may be the latest index in chronological order. The index to be monitored may be an index corresponding to data exceeding the threshold value (the auxiliary line in the horizontal axis direction) concerning the index value V. The index to be monitored may be selected based on a combination of a plurality of conditions. The index to be monitored may be selected by a user designating a desired index in the line graph 32G. Detailed information of each data string contributing to the index value V in the index to be monitored is displayed in the region 33. The index to be monitored may be selected from predetermined time-series information. The index to be monitored may be a date on which the display screen 3 is displayed or a date closest to this date (for example: a day before, a next day).

The region 33 displays detailed information of the data strings contributing to the index value V in the index to be monitored. The data strings correspond to the M kinds of data strings in the table 200. A display mode of the region 33 is determined based on the contribution degrees C. of the data strings to the index value V. The region 33 may display the detailed information of the data strings in order from the top in descending order of the contribution degree C. The region 33 has sub-regions 331, 332, and 333 corresponding to the data strings.

The region 33 may selectively display the detailed information of the data strings according to at least one threshold value set for the contribution degree C. In a case where one threshold value is set, the region 33 may display detailed information of a data string whose contribution degree C. is equal to or greater than the threshold value. On the contrary, the region 33 may omit display of detailed information of a data string whose contribution degree C. is less than the threshold value. In a case where a plurality of threshold values is set, the region 33 may emphasize detailed information of a specific data string whose contribution degree C. is greater than or equal to a specific threshold value, for example, by coloring the detailed information of the specific data string in a different color. In the region 33, sizes of the sub-regions 331, 332, and 333 may be changed depending on the contribution degrees C. of the data strings.

The sub-region 331 displays, as a two-axis line graph 331G, data transition and contribution degree transition as for a data string N having the highest contribution degree C. The contribution degree C. of the data string N is “80”. The vertical axis of the line graph 331G indicates a data value or a contribution degree. The horizontal axis of the line graph 331G indicates a date (index). The date (or period) of the line graph 331G is the same as the date (or period) of the line graph 32G. In the line graph 331G, the transition (data transition) of the data value related to the data string N is indicated by a solid line, and the transition (contribution degree transition) of the contribution degree C. related to the data string N is indicated by a broken line. The user may select a check box related to the data transition or the contribution degree transition. In a case where the check box is selected, the data transition or the contribution degree transition corresponding to the selected check box is displayed.

At least one of the data transition and the contribution degree transition in the line graph 331G may be displayed by a bar graph or the like. The data transition and the contribution degree transition may be displayed as separate graphs. The separate graphs may be switched in response to user's operation. In a case where the data transition is displayed by a bar graph, a color of the bar graph may be changed depending on the contribution degree C. A known display method can be applied to the data transition and the contribution degree transition.

The sub-region 332 displays detailed information for a data string 3 having the second highest contribution degree C. The sub-region 333 displays detailed information for a data string 2 having the lowest contribution degree C. In response to user's selection of the sub-region 332 or 333, detailed information regarding the selected sub-region 332 or 333 may be displayed. In this case, the currently displayed sub-region 331 is folded, and the selected sub-region 332 or 333 is expanded to display the detailed information. A method of displaying the detailed information related to the selected sub-region 332 or 333 is similar to the method of displaying the detailed information related to the sub-region 331.

According to the first embodiment described above, the data monitoring assistance apparatus 1 displays the analysis result related to the operation data OD of the device on the display screen 3. On the display screen 3, the line graph 32G displays the transition of the index value V related to the device number 1, and the line graph 331G displays at least one of the data transition and the contribution degree transition related to the data string N whose contribution degree C. on the index to be monitored “2024 Apr. 5” is relatively large. Therefore, the data monitoring assistance apparatus 1 can supplement information necessary for the user to determine the maintenance time and the maintenance work of the device. The data monitoring assistance apparatus 1 can assist monitoring of an operating state of the device.

The data monitoring assistance apparatus 1 may display at least one of the index value transition, the data transition, and the contribution degree transition on the display screen 3. For example, the data monitoring assistance apparatus 1 displays the index value transition related to the operation data OD of the device on the line graph 32G, and displays the data transition and the contribution degree transition related to the data string N having a relatively large contribution degree C. on the line graph 331G. This display allows the user to easily recognize a possibility that there is another data string different from the data string N and having a relatively high contribution degree C.

For example, according to the index value transition of the line graph 32G, the index value V related to the device number 1 exceeds the threshold value on the index to be monitored “2024 Apr. 5” and another index “2024 Apr. 2”. According to the data transition and the contribution degree transition related to the data string N of the line graph 331G, the contribution degree C. to the data value is high on the index to be monitored “2024 Apr. 5”, and the contribution degree C. to the data value is low on the other index “2024 Apr. 2”. Therefore, the user can recognize that a main cause of the index value V exceeding the threshold value on the index to be monitored “2024 Apr. 5” is the data string N. The user can easily recognize a possibility that a main cause of the index value V exceeding the threshold value on the other index “2024 Apr. 2” is another data string different from the data string N.

Furthermore, the data monitoring assistance apparatus 1 displays the display screen 3 in the display mode determined based on the contribution degree C. For example, the data monitoring assistance apparatus 1 displays detailed information of the data strings from the top in descending order of the contribution degree C. in the region 33 of the display screen 3. This display allows the user to preferentially monitor the detailed information related to the data string N having the relatively high contribution degree C. as compared with the detailed information related to the data string 3 or the data string 2 having the relatively low contribution degree C.

### Modification 1 of First Embodiment

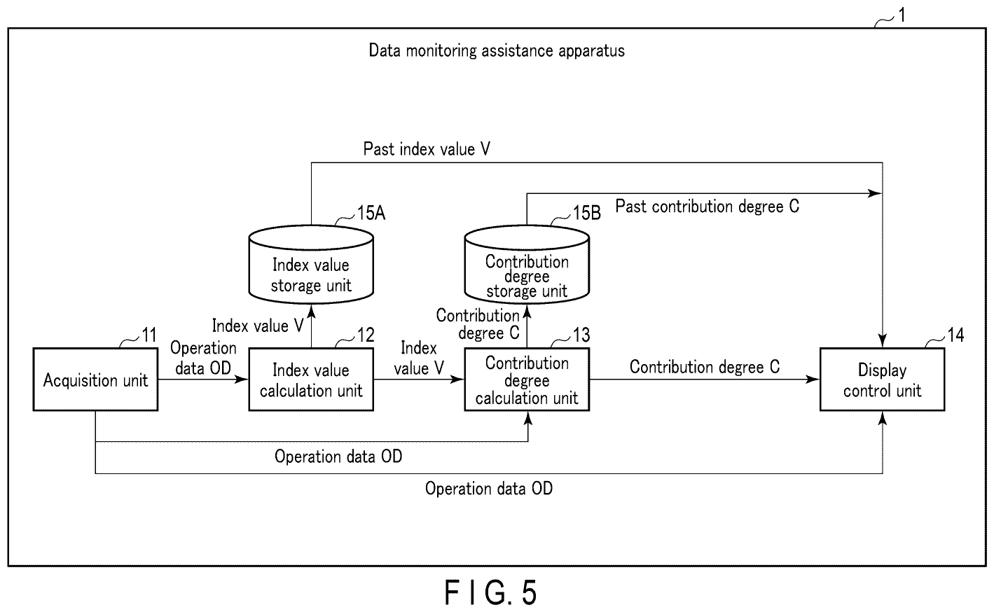

FIG. 5 is a functional configuration diagram of a data monitoring assistance apparatus 1 according to Modification 1 of the first embodiment. According to Modification 1, the data monitoring assistance apparatus 1 includes an index value storage unit 15A and a contribution degree storage unit 15B in addition to the acquisition unit 11, the index value calculation unit 12, the contribution degree calculation unit 13, and the display control unit 14. The data monitoring assistance apparatus 1 may include any one of the index value storage unit 15A and the contribution degree storage unit 15B. The index value storage unit 15A and the contribution degree storage unit 15B may be integrated into one storage unit.

The index value storage unit 15A stores the index value V calculated by the index value calculation unit 12. The index value storage unit 15A transmits a stored past index value V to the display control unit 14. The contribution degree storage unit 15B stores the contribution degree C. calculated by the contribution degree calculation unit 13. The contribution degree storage unit 15B transmits a stored past contribution degree C. to the display control unit 14. The display control unit 14 displays transition of the index value V and transition of the contribution degree C. based on the received index value V and contribution degree C.

According to Modification 1 of the first embodiment described above, the data monitoring assistance apparatus 1 stores the calculated index value V in the index value storage unit 15A, and stores the calculated contribution degree C. in the contribution degree storage unit 15B. Therefore, the data monitoring assistance apparatus 1 does not need to recalculate the already calculated index value V and contribution degree C. The data monitoring assistance apparatus 1 can quickly display the transition of the index value V and the transition of the contribution degree C. by using the already calculated index value V and contribution degree C.

### Modification 2 of First Embodiment

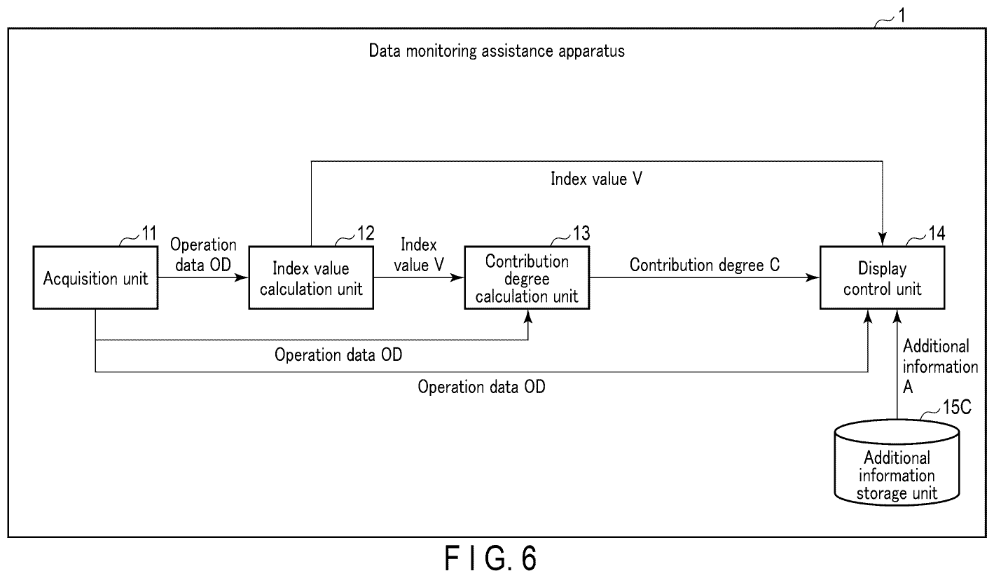

FIG. 6 is a functional configuration diagram of a data monitoring assistance apparatus 1 according to Modification 2 of the first embodiment. According to Modification 2, the data monitoring assistance apparatus 1 includes an additional information storage unit 15C in addition to the acquisition unit 11, the index value calculation unit 12, the contribution degree calculation unit 13, and the display control unit 14.

The additional information storage unit 15C stores additional information A. The additional information A may be information on groups to which the data strings in the table 200 belong. The additional information A may be information on numerical values or an order defined for the data strings. The additional information storage unit 15C transmits the stored additional information A to the display control unit 14.

First, the device may include a plurality of modules (parts). In this case, the additional information A may be names of modules to which the data strings of the table 200 belong. The additional information A may be numbers indicating an order in which the modules operate.

Secondly, a degree of importance of monitoring or a degree of relevance to a failure of the device is sometimes already known for each data string in the table 200. In this case, the additional information A may be a numerical value or a number indicating the degree of importance or the degree of relevance. The additional information A may be names (for example: a degree of importance 1, a degree of importance 2) of importance degree groups to which the data strings belong.

The display control unit 14 determines the display mode of the region 33 on the display screen 3 based on the additional information A. First, it is assumed that the additional information A is names of groups to which the data strings belong. In this case, the display control unit 14 may display the names of the data strings and the names of the groups. The display control unit 14 may divide the region 33 into a plurality of small sections and then display the names of the data strings and the names of the groups in the divided sections. The display control unit 14 may display the names of the groups in descending order or ascending order of the contribution degree C.

Second, it is assumed that the additional information A is information on numerical values or an order defined for the data strings. In this case, the display control unit 14 may display the detailed information of the data strings in descending order or ascending order of the numerical value. The display control unit 14 may display the detailed information of the data strings according to the order. The display control unit 14 may determine the display mode of the data strings based on a numerical value (for example: sum, product) calculated from the numerical values and the contribution degrees C.

The display control unit 14 may switch the display mode based on the contribution degree C. and the display mode based on the additional information A in response to user's operation or the like.

According to Modification 2 of the first embodiment described above, the data monitoring assistance apparatus 1 determines the display mode related to the data strings based on the additional information A, and displays the additional information A. The additional information A includes information useful for monitoring data related to each data string. The user can further recognize, as the displayed additional information A, importance of monitoring, relevance to a failure of the device, or the like related to each data string.

### Second Embodiment

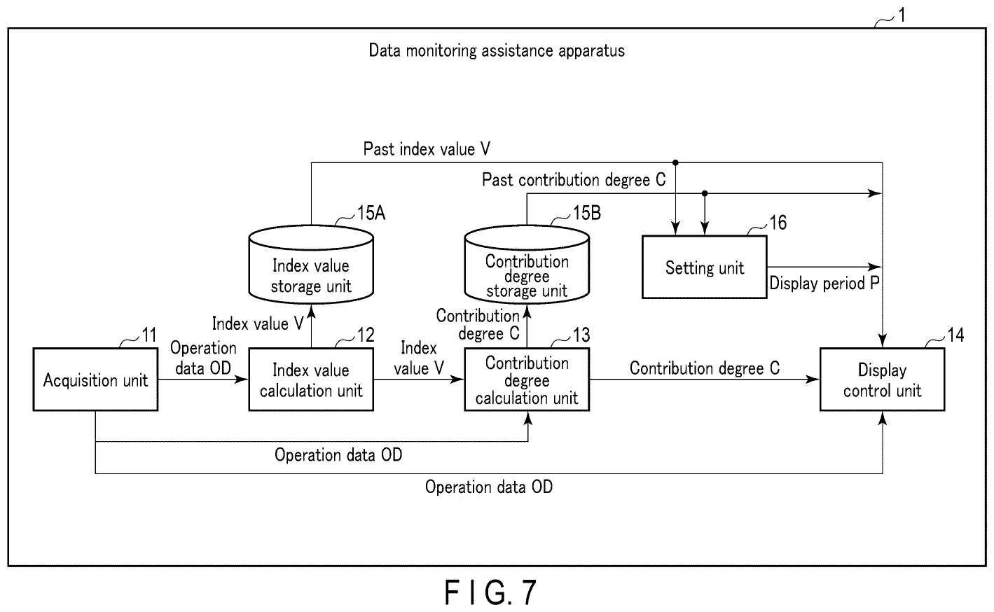

FIG. 7 is a functional configuration diagram of a data monitoring assistance apparatus 1 according to a second embodiment. According to the second embodiment, the data monitoring assistance apparatus 1 includes a setting unit 16 in addition to an acquisition unit 11, an index value calculation unit 12, a contribution degree calculation unit 13, a display control unit 14, an index value storage unit 15A, and a contribution degree storage unit 15B.

The setting unit 16 sets various kinds of data. The setting unit 16 receives a past index value V from the index value storage unit 15A and receives a past contribution degree C. from the contribution degree storage unit 15B. The setting unit 16 sets a display period P related to transition of the index value V and a display period P related to transition of the contribution degree C. based on the received index value V and contribution degree C. Both the display periods P may be the same period or may be different periods. The setting unit 16 transmits the set display period P to the display control unit 14.

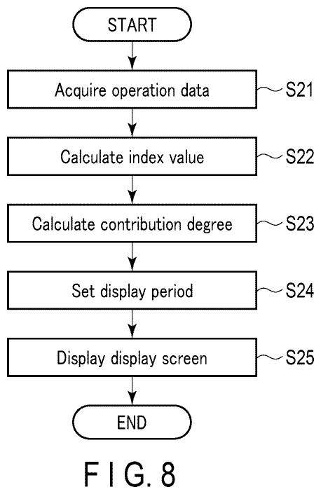

FIG. 8 is an operation flowchart of the data monitoring assistance apparatus 1 according to the second embodiment. The data monitoring assistance apparatus 1 executes processes related to steps S21 to S25.

(Steps S21 to S23) First, the data monitoring assistance apparatus 1 executes steps S21 to S23. Steps S21 to S23 are similar to steps S11 to S13.
(Step S24) Next, the data monitoring assistance apparatus 1 sets the display period P through the setting unit 16. The setting unit 16 uses operation data OD acquired in step S21 and the index value V and the contribution degree C. calculated in steps S22 and S23. The setting unit 16 sets the display period P based on the operation data OD, the index value V, and the contribution degree C.

The setting unit 16 may set any period (for example: 1 week, 1 month) as the display period P regarding a table 200. In a case where indexes are sequential numbers, the setting unit 16 may set any number of rows of the table 200 as the display period P. For example, the setting unit 16 may set a plurality of indexes going back from a predetermined index as the display period P.

The setting unit 16 may set the display period P based on the index value V or the contribution degree C. The setting unit 16 may set, as the display period P, a period from an index of predetermined data to an index of data whose index value V or contribution degree C. is equal to or less than a threshold value. As a result, transition of the index value V or the contribution degree C. during a period going back from the index of the predetermined data to the index where it is estimated that the device is normal is displayed. This makes it easy to compare data of the device during a normal state with data of the device at a predetermined time point. The threshold value for the index value V or the contribution degree C. may be set to any value by a user.

On the contrary, the setting unit 16 may set, as the display period P, a period from an index of predetermined data to an index of data whose index value V or contribution degree C. is equal to or greater than a threshold value. As a result, transition of the index value V or the contribution degree C. during a period going back from the index of the predetermined data to the index where it is estimated that last device failure or failure sign occurred. This makes it easy to check the transition of the index value V or the contribution degree C. from the last device failure or failure sign.

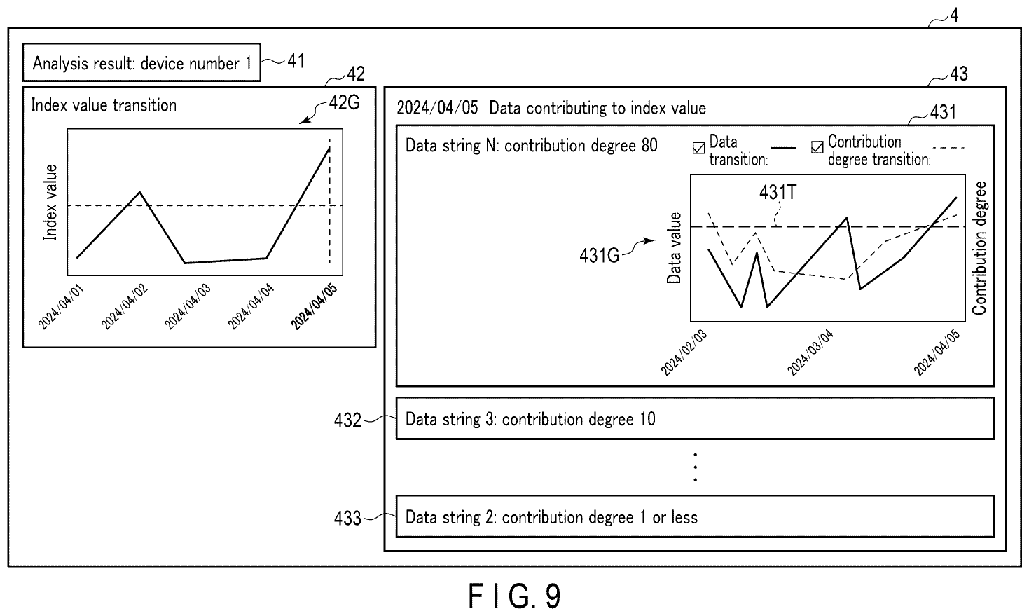

(Step S25) Finally, the data monitoring assistance apparatus 1 displays a display screen through the display control unit 14. The display control unit 14 generates display data (or image data) for displaying the display screen based on the display period P set in step S24. The display control unit 14 outputs the generated display data to the display device. The display device displays the display screen based on the display data (see FIG. 9).

The display control unit 14 may include additional information A in the display data based on a condition used by the setting unit 16 to set the display period P, event information (described later), and the like.

FIG. 9 is a diagram illustrating a display screen 4 according to the second embodiment. The display screen 4 is similar to the display screen 3. The display screen 4 includes three regions 41, 42, and 43. The region 41 is similar to the region 31. The region 42 and a line graph 42G are similar to the region 32 and the line graph 32G, respectively. The region 43 is similar to the region 33. Sub-regions 431, 432, and 433 are similar to the sub-regions 331, 332, and 333, respectively.

The sub-region 431 displays, as a line graph 431G, data transition and contribution degree transition as for a data string N having the highest contribution degree C. In the line graph 431G, the display period P is a period from an index to be monitored “2024 Apr. 5” to an index “2024 Feb. 3”. The display period P is set based on a threshold value 431T related to the contribution degree C. The display period P is a period going back from the index to be monitored “2024 Apr. 5” to the index “2024 Feb. 3” where the contribution degree C. is equal to or greater than the threshold value 431T. The threshold value 431T is the additional information A and is displayed as a broken line in the horizontal axis direction in the line graph 431G.

According to the second embodiment described above, the data monitoring assistance apparatus 1 displays data transition, index value transition, and contribution degree transition during the display period P. For example, the data monitoring assistance apparatus 1 sets, as the display period P, a period from an index of predetermined data to an index of data whose index value V or contribution degree C. is equal to or greater than a threshold value. In this case, the user can easily compare a state of a device during a normal state with a state of the device during occurrence of a last failure or failure sign.

### Modification 3 of Second Embodiment

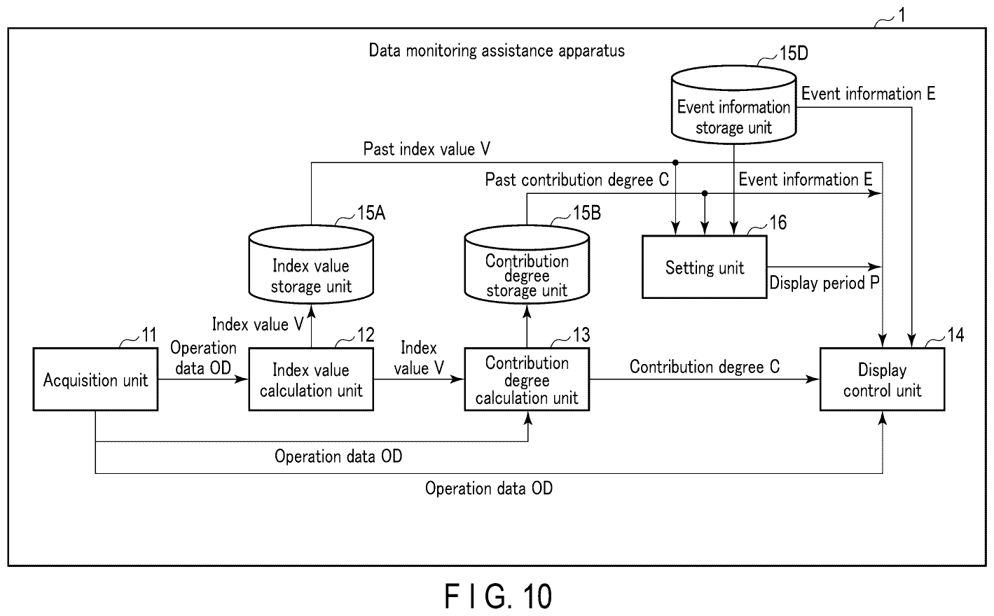

FIG. 10 is a functional configuration diagram of a data monitoring assistance apparatus 1 according to Modification 3 of the second embodiment. According to Modification 3, the data monitoring assistance apparatus 1 includes an event information storage unit 15D in addition to the acquisition unit 11, the index value calculation unit 12, the contribution degree calculation unit 13, the display control unit 14, the index value storage unit 15A, the contribution degree storage unit 15B, and the setting unit 16.

The event information storage unit 15D stores event information E. The event information E is an event related to an operating status or a failure probability of a device. For example, the event information E is time information (for example, date) indicating a time when the event occurred. The event information E is associated with the index of the table 200.

The event information E is information related to an event that occurred regarding the device during a predetermined period. The event information E is a date on which the device was introduced, a date on which maintenance work of the device was performed, a date on which a part or all of the device was replaced, a date on which the device failed, or the like. The event information E may be information concerning an external event. The event information E is a date such as a weekday, a holiday, a national holiday, a busy season, or an off season. The event information E may be information concerning an operation schedule of the device.

The setting unit 16 sets the display period P based on the event information E. For example, the setting unit 16 sets, as the display period P, a period from an index of a predetermined data to an index corresponding to the event information E. The user can easily check data transition, index value transition, and contribution degree transition during the display period P from the event of the device to a time point corresponding to the predetermined data.

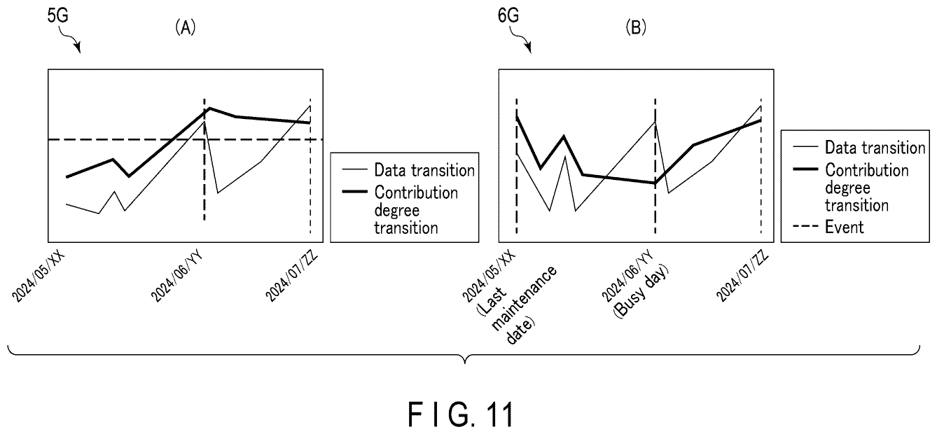

FIG. 11 is a diagram illustrating line graphs 5G and 6G according to Modification 3 of the second embodiment. FIG. 11(A) illustrates the line graph 5G. FIG. 11(B) illustrates a line graph 6G. The line graph 5G or 6G may be displayed instead of the line graph 331G in the region 33.

As illustrated in FIG. 11(A), in the line graph 5G, data transition is displayed by a thin solid line, and contribution degree transition is displayed by a thick solid line. In the line graph 5G, a threshold value set for the contribution degree C. is displayed by a broken line in the horizontal axis direction. The display period P in the line graph 5G is a period from an index to be monitored “2024/07/ZZ” to an index “2024/05/XX”. The contribution degree C. on the index to be monitored “2024/07/ZZ” is equal to or greater than the threshold value. The contribution degree C. on the index “2023/05/XX” is equal to or less than the threshold value. The display period P is a certain period from the time point of the index to be monitored to the time point at which the contribution degree C. is equal to or less than the threshold value.

As illustrated in FIG. 11(B), in the line graph 6G, data transition is displayed by a thin solid line, and contribution degree transition is displayed by a thick solid line. In the line graph 6G, a date (maintenance date) when maintenance work of the device was performed last time and a busy day are displayed by a thick broken line in the vertical axis direction. The event information E includes “2024/05/XX”, which is the last maintenance date, and “2024/06/YY”, which is a busy day. The display period P is a period from the time point of the index to be monitored to the last maintenance date.

According to Modification 3 of the second embodiment described above, the data monitoring assistance apparatus 1 displays data transition, index value transition, and contribution degree transition during the display period P from a predetermined time point to a time point based on the event information E. The user can easily compare a state of a device at a predetermined time point with a state of the device at a time of occurrence of an event.

### Third Embodiment

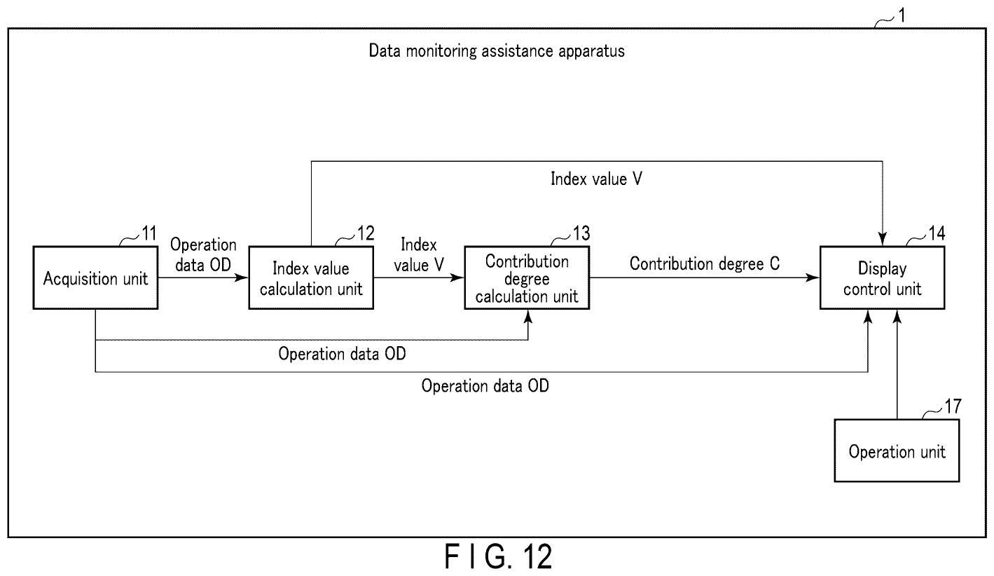

FIG. 12 is a functional configuration diagram of a data monitoring assistance apparatus 1 according to a third embodiment. According to the third embodiment, the data monitoring assistance apparatus 1 includes an operation unit 17 in addition to an acquisition unit 11, an index value calculation unit 12, a contribution degree calculation unit 13, and a display control unit 14.

The operation unit 17 performs various operations in response to user's operation. The operation unit 17 receives user's operation, and operates or changes display data output from the display control unit 14. In this case, the display data is data in a format such as HTML. The operation unit 17 receives operation performed by a mouse, a touch panel, a keyboard, or the like. The display control unit 14 may display a graphical user interface (GUI) such as a button or a scroll bar.

The operation unit 17 may change a display period P related to at least one of data transition, index value transition, and contribution degree transition. For example, the user changes the display period P by operating a GUI for changing the display period P. The display control unit 14 may display the data transition, the index value transition, and the contribution degree transition during the changed display period P.

The user may change an index to be monitored by selecting the index value display (the region 32 in FIG. 4). For example, the user may select an index in the index value display, and data transition and contribution degree transition (the region 33 in FIG. 4) corresponding to the selected index may be displayed. In a case where a display mode based on the contribution degree C. and a display mode based on the additional information A are selectable, the display mode based on the contribution degree C. and the display mode based on the additional information A may be switched by user's operation.

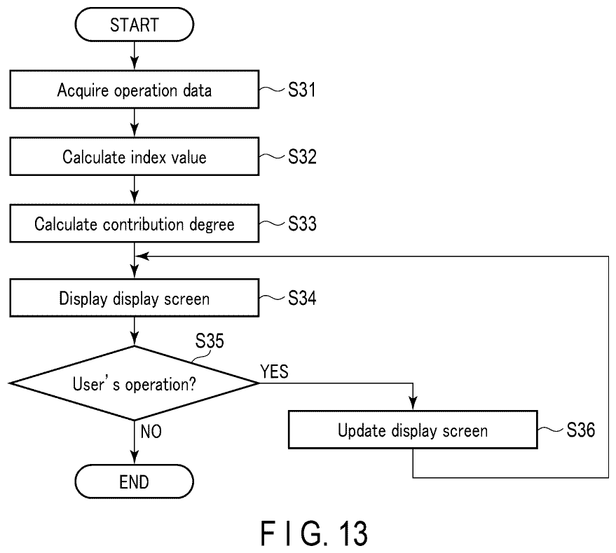

FIG. 13 is an operation flowchart of the data monitoring assistance apparatus 1 according to the third embodiment. The data monitoring assistance apparatus 1 executes processes related to steps S31 to S36.

(Steps S31 to S34) First, the data monitoring assistance apparatus 1 executes steps S31 to S34. Steps S31 to S34 are similar to steps S11 to S14.
(Step S35) In this step, the data monitoring assistance apparatus 1 determines whether or not user's operation has been input through the operation unit 17. In a case where user's operation has been input (step S35-YES), the processing proceeds to step S36. In a case where user's operation has not been input (step S35-NO), the data monitoring assistance apparatus 1 ends the series of processes.
(Step S36) In this case, the data monitoring assistance apparatus 1 updates a display screen through the display control unit 14. The display control unit 14 updates a currently displayed display screen in response to the user's operation. After step S36, the processing returns to step S34.

According to the third embodiment described above, the data monitoring assistance apparatus 1 changes a display mode of a display screen in response to user's operation. The data monitoring assistance apparatus 1 displays the display screen in the changed display mode. Therefore, the data monitoring assistance apparatus 1 can present information necessary for the user.

### Fourth Embodiment

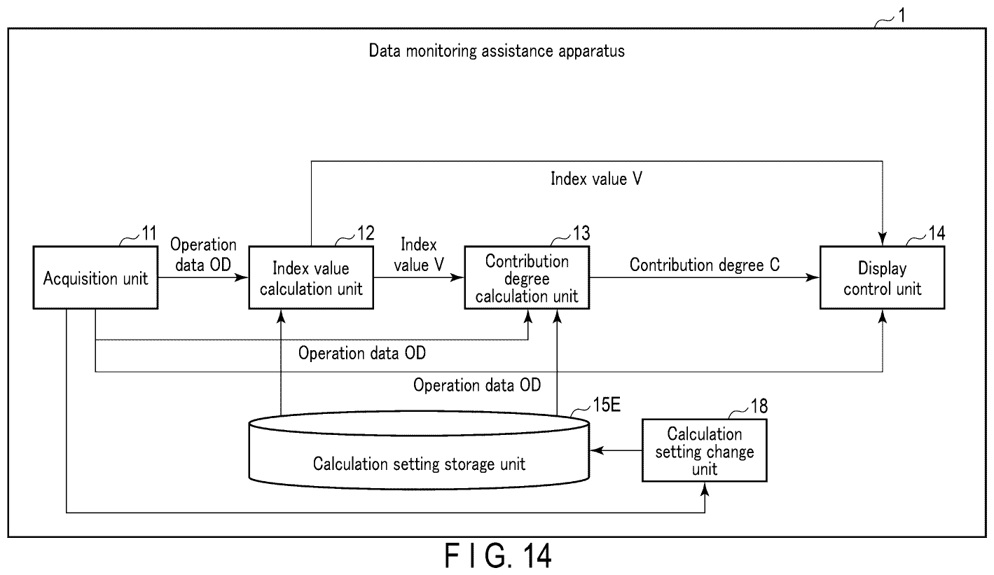

FIG. 14 is a functional configuration diagram of a data monitoring assistance apparatus 1 according to a fourth embodiment. According to the fourth embodiment, the data monitoring assistance apparatus 1 includes a calculation setting storage unit 15E and a calculation setting change unit 18 in addition to an acquisition unit 11, an index value calculation unit 12, a contribution degree calculation unit 13, and a display control unit 14.

The calculation setting storage unit 15E stores setting information related to calculation of an index value V and a contribution degree C. The setting information is a model (or an algorithm) related to a calculation method, a machine learning model, or the like.

The calculation setting change unit 18 changes setting related to calculation of the index value V and the contribution degree C. The calculation setting change unit 18 may change a parameter designated by a user or the like among parameters related to the index value calculation unit 12 or the contribution degree calculation unit 13. For example, in a case where there are a plurality of calculation methods that can be executed by the index value calculation unit 12 or the contribution degree calculation unit 13, the calculation setting change unit 18 switches a calculation method among the plurality of calculation methods. In a case where there are a plurality of parameters related to a threshold value, a constant number, or the like, the calculation setting change unit 18 may switch a parameter among the plurality of parameters.

The calculation setting change unit 18 may change or update a model used by the index value calculation unit 12 or the contribution degree calculation unit 13. The calculation setting change unit 18 may change a degree of influence (or a weight) related to index value calculation or contribution degree calculation regarding a data string selected in response to user's operation or the like on a table 200.

The calculation setting change unit 18 may change the calculation setting by excluding the selected data string from a target of the index value calculation or the contribution degree calculation. The calculation setting change unit 18 may change the calculation setting by calculating an average, a median value, or the like during a certain period for data related to the selected data string and replacing the data with the calculated value. It is assumed that a machine learning model is used, and standardization is performed as preprocessing so that an average is 0 and a variance is 1. In this case, a value of the data string input to the machine learning model may be replaced with 0. In a case where the machine learning model is a regression model or a neural network, a coefficient related to the data string may be replaced with 0. In a case where a statistical model or a machine learning model is used, the calculation setting change unit 18 may reconstruct the model by excluding the selected data string. By these changes, influence of the selected data string on the index value calculation or the contribution degree calculation can be removed (or reduced).

The calculation setting change unit 18 may change a predetermined value so as to emphasize or attenuate the predetermined value. In a case where a regression model or a neural network is used, the calculation setting change unit 18 may weight a coefficient related to the selected data string so as to increase or decrease the coefficient. In addition, similar processing may be executed.

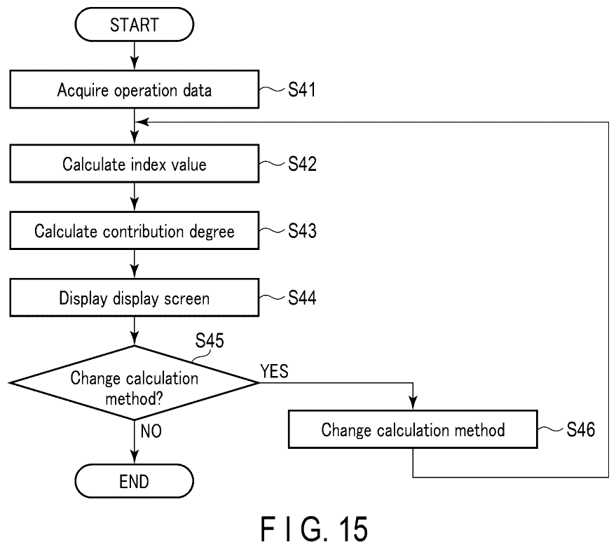

FIG. 15 is an operation flowchart of the data monitoring assistance apparatus 1 according to the fourth embodiment. The data monitoring assistance apparatus 1 executes processes related to steps S41 to S46.

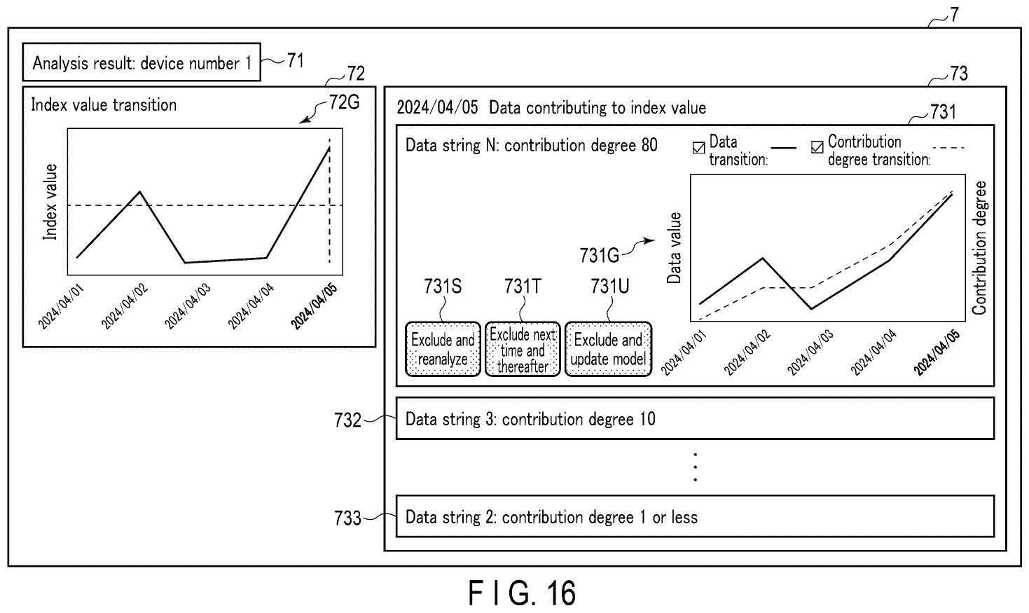

(Steps S41 to S44) First, the data monitoring assistance apparatus 1 executes steps S41 to S44. Steps S41 to S44 are similar to steps S11 to S14.
(Step S45) In this step, the data monitoring assistance apparatus 1 determines whether or not to change the calculation method through the calculation setting change unit 18. In a case where the calculation method is changed (step S45-YES), the processing proceeds to step S46. In a case where the calculation method is not changed (step S45-NO), the data monitoring assistance apparatus 1 ends the series of processes.
(Step S46) Subsequently, the data monitoring assistance apparatus 1 changes the calculation method through the calculation setting change unit 18. After step S46, the processing returns to step S42. In steps S42 and S43 executed again, the index value V and the contribution degree C. are re-calculated by the changed calculation method. In step S44, a display screen based on the recalculated index value V and contribution degree C. is displayed (see FIG. 16).

FIG. 16 is a diagram illustrating a display screen 7 according to the fourth embodiment. The display screen 7 is similar to the display screen 3. The display screen 7 includes three regions 71, 72, and 73. The region 71 is similar to the region 31. The region 72 and a line graph 72G are similar to the region 32 and the line graph 32G, respectively. The region 73 is similar to the region 33. Sub-regions 731, 732, and 733 are similar to the sub-regions 331, 332, and 333, respectively.

The sub-region 731 includes three GUI buttons 731S, 731T, and 731U. The GUI button 731S includes a text “Exclude and reanalyze”. The GUI button 731T includes a text “Exclude next time and thereafter”. The GUI button 731U includes a text “Exclude and update model”. The three GUI buttons 731S, 731T, and 731U select and exclude a corresponding data string (data string N).

In a case where the user presses the GUI button 731S, index value calculation and contribution degree calculation excluding the data string N are performed, and a new display screen 7 is displayed. In a case where the user presses the GUI button 731T, the calculation setting is recorded, and the data string N is automatically excluded in the next and subsequent data analysis. In a case where the user presses the GUI button 731U, a statistical model or a machine learning model excluding the data string N is reconstructed (or retrained).

In a case where the calculation setting is changed by the calculation setting change unit 18, the index value calculation unit 12 or the contribution degree calculation unit 13 may recalculate the index value V or the contribution degree C. based on the changed calculation setting. The display control unit 14 may re-output (update) display data based on the re-calculated result. The display control unit 14 may display the display data before the change of the calculation setting and the display data after the change of the calculation setting. These two pieces of display data may be switched by an operation unit 17, and the display control unit 14 may display a selected one of these two pieces of display data.

### Modification 4 of Fourth Embodiment

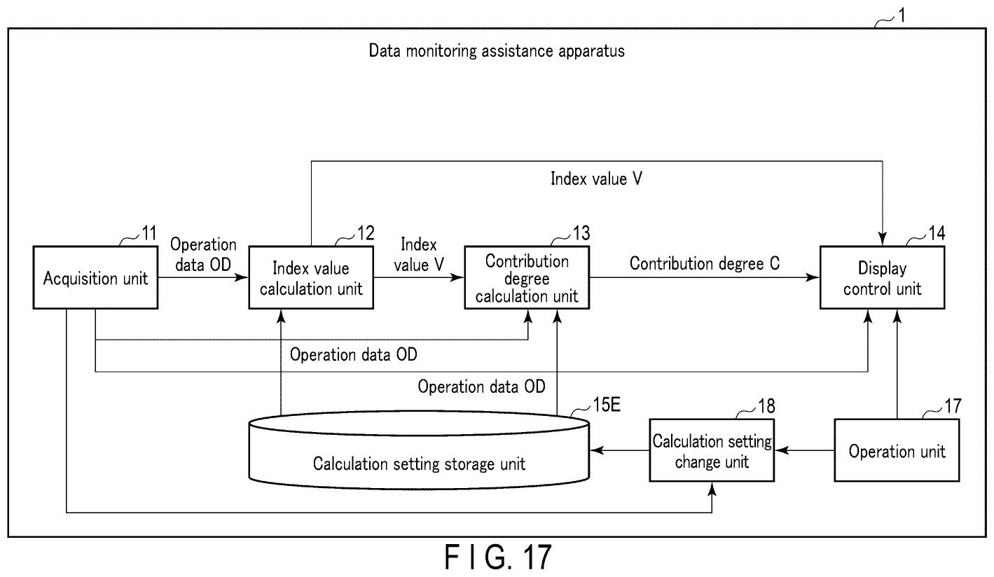

FIG. 17 is a functional configuration diagram of a data monitoring assistance apparatus 1 according to Modification 4 of the fourth embodiment. According to Modification 4, the data monitoring assistance apparatus 1 includes the operation unit 17 in addition to the acquisition unit 11, the index value calculation unit 12, the contribution degree calculation unit 13, the display control unit 14, the calculation setting storage unit 15E, and the calculation setting change unit 18.

The operation unit 17 may control operation of the calculation setting change unit 18 in response to user's operation. The display data output from the display control unit 14 may include a GUI (for example: the GUI buttons 731S, 731T, and 731U) for controlling operation of the calculation setting change unit 18. The operation unit 17 and the calculation setting change unit 18 may be integrated into one functional unit.

According to the fourth embodiment described above, the data monitoring assistance apparatus 1 changes calculation setting related to the index value V or the contribution degree C. By this change, the data monitoring assistance apparatus 1 can present a calculation result selected from among a plurality of calculation results or selected by switching among a plurality of calculation results. This can assist user's determination from multiple points of view.

### Fifth Embodiment

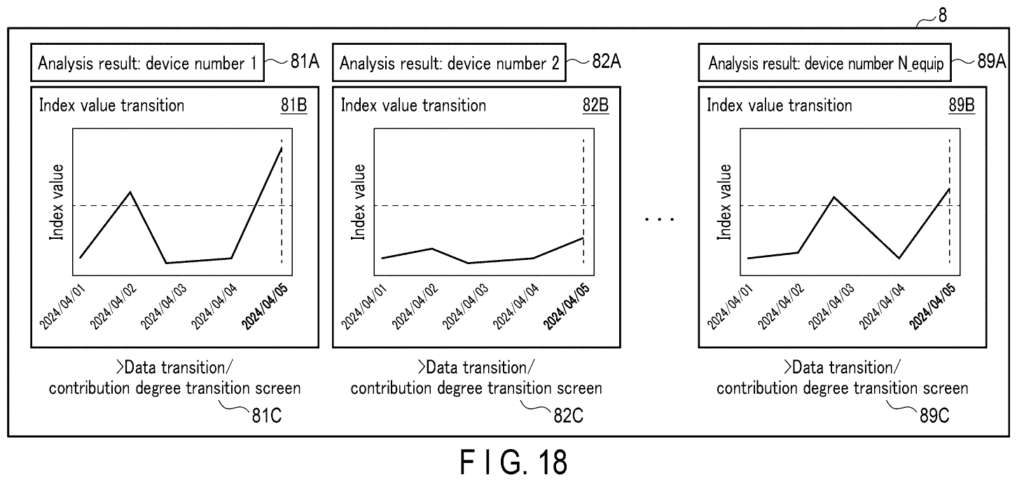

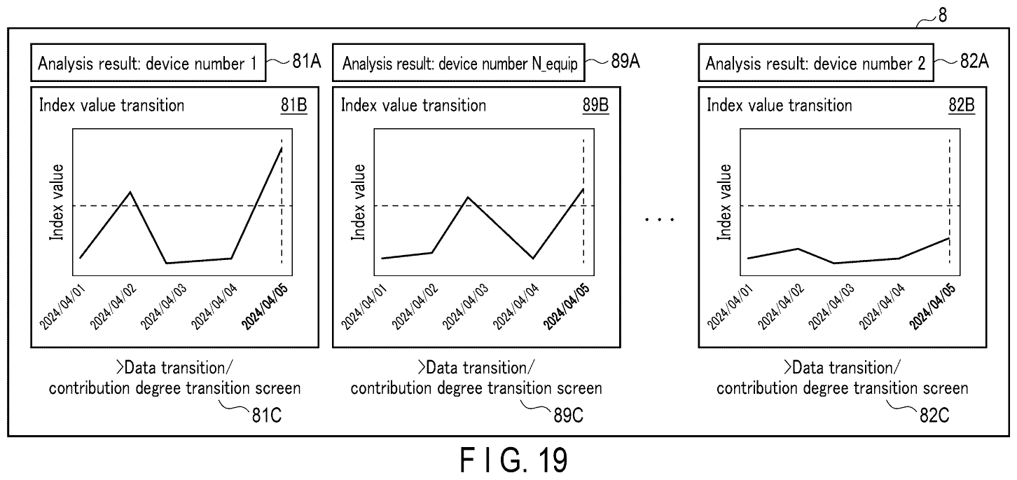

The data monitoring assistance apparatuses 1 according to the first to fourth embodiments monitor operation data OD related to one specific device. A data monitoring assistance apparatus 1 according to the fifth embodiment monitors operation data OD related to a plurality of (or a large number of) devices. In this case, the data monitoring assistance apparatus 1 repeats, for each of the plurality of devices, processing similar to the processing for the specific one device. The data monitoring assistance apparatus 1 outputs display data related to a display screen by integrating processing results for the plurality of devices (see FIGS. 18 and 19).

FIG. 18 is a diagram illustrating a first example of a display screen 8 according to the fifth embodiment. The display screen 8 according to the first example shows analysis results of the operation data OD regarding a plurality of devices (a device number 1, a device number 2, . . . , and a device number N_equip). The display screen 8 displays the analysis result related to the device number 1 in regions 81A, 81B, and 81C. The display screen 8 displays the analysis result related to the device number 2 in regions 82A, 82B, and 82C. The display screen 8 displays the analysis result related to the device number N_equip in regions 89A, 89B, and 89C.

The regions 81A, 82A, and 89A specifies the devices whose operation data OD has been analyzed. The regions 81A, 82A, and 89A are similar to the region 31 (see FIG. 4).

The regions 81B, 82B, and 89B display transition of index values V calculated for the devices as line graphs. The regions 81B, 82B, and 89B are similar to the region 32 (see FIG. 4). The regions 81B, 82B, and 89B display index value transition related to the devices in an order of the device number.

The regions 81C, 82C, and 89C are GUI buttons for displaying data transition and contribution degree transition for the devices. In a case where the user clicks one of the GUI buttons, the currently displayed screen is switched to a screen of data transition and contribution degree transition related to a device number corresponding to the clicked GUI button. The screen after the switching is similar to the region 33 (see FIG. 4). For example, in a case where the region 81C is clicked, data transition and contribution degree transition related to the device number 1 are displayed instead of the region 81B. Based on the display screen 8, the user can simultaneously recognize the index values V (for example: deviation degrees from a normal state) and the like related to a plurality of devices that need monitoring.

FIG. 19 is a diagram illustrating a second example of the display screen 8 according to the fifth embodiment. The display screen 8 according to the second example displays the analysis results regarding the plurality of devices in descending order of the index value V on an index to be monitored “2024 Apr. 5”. Specifically, the analysis result is displayed in the order of the device number 1, the device number N equip, . . . , and the device number 2. Based on the display screen 8, the user can preferentially monitor a device having a high probability of occurrence of an anomaly or an anomaly sign.

According to the fifth embodiment described above, the data monitoring assistance apparatus 1 displays analysis results related to a plurality of devices on a display screen in a predetermined order (for example: in an order of the device number, in a descending order of the index value V). The user can easily prioritize the displayed analysis results and check details of the analysis results. Therefore, the data monitoring assistance apparatus 1 can reduce a burden of a user monitoring a plurality of devices.

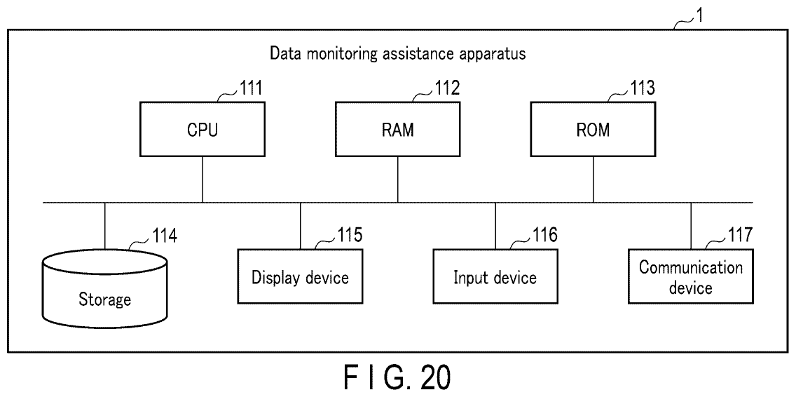

FIG. 20 is a hardware configuration diagram of the data monitoring assistance apparatus 1 according to each embodiment. The data monitoring assistance apparatus 1 includes a CPU 111, a RAM 112, a ROM 113, a storage 114, a display device 115, an input device 116, and a communication device 117 as constituent elements. The constituent elements are communicably connected to each other by an internal bus. The data monitoring assistance apparatus 1 may include at least one or some of the constituent elements. Each unit of the data monitoring assistance apparatus 1 may exist on cloud or on-premise.

The CPU 111 is a processor that executes various kinds processing in accordance with programs. The CPU 111 uses a predetermined area of the RAM 112 as a work area. The CPU 111 reads and executes programs stored in the ROM 113 or the storage 114 and thereby realize the units (for example: the acquisition unit 11, the index value calculation unit 12, the contribution degree calculation unit 13, the display control unit 14, the setting unit 16, the operation unit 17, the calculation setting change unit 18). The CPU 111 is an example of a processing unit.

The RAM 112 is a memory that stores various kinds of data in a rewritable manner. The RAM 112 is a synchronous dynamic random access memory (SDRAM) or the like. The ROM 113 is a memory that stores various kinds of data in a non-rewritable manner. The storage 114 is a storage medium of various kinds. The storage 114 may be a drive device that writes or reads various kinds of data into or from a storage medium. The storage 114 may write or read various kinds of data to or from a storage medium under control of the CPU 111. The RAM 112, the ROM 113, and the storage 114 are an example of a storage unit (for example: the index value storage unit 15A, the contribution degree storage unit 15B, the additional information storage unit 15C, the event information storage unit 15D, the calculation setting storage unit 15E).

The display device 115 is a device that displays various kinds of data. The display device 115 is a liquid crystal display (LCD) or the like. The display device 115 displays various kinds of data (for example, a display screen) based on a display signal from the CPU 111. The display device 115 is an example of a display unit.

The input device 116 is a device that receives various input operations from a user. The input device 116 is a mouse, a keyboard, or the like. The input device 116 receives an operation input by the user as an instruction signal, and transmits the instruction signal to the CPU 111. The input device 116 is an example of an input unit (or the operation unit 17).

The communication device 117 communicates with an external device over a network under control of the CPU 111. The communication device 117 is an example of a communication unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data monitoring assistance apparatus comprising a processor configured to:
acquire a plurality of pieces of time-series data related to an operating state of a device during a predetermined period,
calculate an index value related to a possibility of occurrence of an anomaly sign in the device based on the pieces of time-series data,
calculate a contribution degree to the index value for each of the pieces of time-series data, and
display, on a display device, a display screen including first transition related to the index value during the predetermined period and second transition related to the contribution degree during the predetermined period.

2. The apparatus according to claim 1, wherein
the processor is further configured to display the display screen on the display device in a display mode determined based on the contribution degree.

3. The apparatus according to claim 1, wherein
the processor is further configured to further display transition related to the pieces of time-series data during the predetermined period on the display device.

4. The apparatus according to claim 1, wherein
the processor is further configured to:
set a display period in the predetermined period based on a threshold value related to at least one of the index value and the contribution degree, and
display the first transition during the display period and the second transition during the display period on the display device.

5. The apparatus according to claim 1, wherein
the processor is further configured to:
set a display period in the predetermined period based on event information related to an event that occurred for the device during the predetermined period, and
display the first transition during the display period and the second transition during the display period on the display device.

6. The apparatus according to claim 1, wherein
the processor is further configured to:
change a display period related to at least one of the first transition and the second transition displayed on the display device in response to user's operation, and
display the first transition during the changed display period and the second transition during the changed display period on the display device.

7. The apparatus according to claim 1, wherein
the processor is further configured to:
change a calculation method related to at least one of the index value and the contribution degree in response to user's operation,
recalculate the index value by the changed calculation method, and
recalculate the contribution degree by the changed calculation method.

8. The apparatus according to claim 1, wherein
the processor is further configured to:
acquire the pieces of time-series data for each of devices,
calculate the index value for each of the devices based on the pieces of time-series data,
calculate the contribution degree to the index value for each of the pieces of time-series data, and
display the first transition and the second transition for each of the devices on the display device.

9. A data monitoring assistance method comprising causing a computer to:
acquire a plurality of pieces of time-series data related to an operating state of a device during a predetermined period;
calculate an index value related to a possibility of occurrence of an anomaly sign in the device based on the pieces of time-series data;
calculate a contribution degree to the index value for each of the pieces of time-series data; and
display, on a display device, a display screen including first transition related to the index value during the predetermined period and second transition related to the contribution degree during the predetermined period.

10. A non-transitory computer readable medium including computer executable instructions, wherein the instructions, when executed by a processor, cause the processor to perform a method comprising:
acquiring a plurality of pieces of time-series data related to an operating state of a device during a predetermined period;
calculating an index value related to a possibility of occurrence of an anomaly sign in the device based on the pieces of time-series data;
calculating a contribution degree to the index value for each of the pieces of time-series data; and
displaying, on a display device, a display screen including first transition related to the index value during the predetermined period and second transition related to the contribution degree during the predetermined period.
